(19) United States
(12) Patent Application Publication
(10) Pub. No.: US 2014/0225523 A1
(43) Pub. Date: Aug. 14, 2014

(54) Method for Operating a Light-Emitting Device and Arrangement

(71) Applicant: Novaled GmbH, Dresden (DE)

(72) Inventors: Torsten Coym, Dresden (DE); Sven Murano, Dresden (DE); Oliver Langguth, Dresden (DE)

(73) Assignee: Novaled GmbH, Dresden (DE)

(21) Appl. No.: 14/346,090

(22) PCT Filed: Sep. 19, 2012
(86) PCT No.: PCT/DE2012/100288

§ 371 Date: Mar. 20, 2014

(30) Foreign Application Priority Data
Sep. 23, 2011 (DE) 10 2011 053 902.6

(51) Int. Cl. H05B 33/08

(52) U.S. Cl. CPC H05B 33/0896
USPC 315/210

(57) ABSTRACT

An arrangement and method is provided for operating a light-emitting device, wherein, a pulsed current is generated with a pulse frequency by a driver circuit, which has a clock pulse generator providing clock pulse signals for current pulsing, and a light-emitting device, which functionally couples to the driver circuit and which is formed with one or a plurality of organic light-emitting diodes, is loaded with the pulsed current with a pulse frequency of approximately 10 kHz to approximately 100 kHz, wherein: T_PWM<(T_rise+T_fall) and wherein T_PWM indicates the pulse length for the clock pulse signals generated by the clock pulse generator of the driver circuit and T_rise and also T_fall indicate the pulse rise time and the pulse fall time for the current pulses present at the one or the plurality of organic light-emitting diodes.

### FIELD OF THE INVENTION

The invention relates to a method for operating a light-emitting device, which is formed with one or a plurality of organic light-emitting diodes, and also an arrangement with such a device.

### BACKGROUND

Light-emitting devices of this type can be used in different design variants, which include light-emitting devices constructed as illumination apparatus in particular. Organic light-emitting diodes (OLEDs) are becoming more and more important in this context. Similarly to inorganic light-emitting diodes (LEDs) OLEDs are controlled in a current-driven manner. However, there are also a few fundamental differences between these types of light-emitting diodes with regards to requirements and properties. This is the reason why specifically set-up driver apparatuses are necessary for light-emitting devices with organic light-emitting diodes.

LEDs are usually operated by means of a pulsed current, wherein the brightness of the LEDs is controlled by means of pulse width. A variation of the driver current however is not provided in commercially available LED drivers. LED drivers can be used in principle for the operation of OLEDs, however brightness regulation by means of PWM (pulse-width modulation) can disadvantageously affect the service life for the OLED, as the OLEDs are operated at effectively higher brightnesses and the ageing of OLEDs increases exponentially with the brightness.

LED drivers are furthermore also only available with a few commercially available rated currents, which is caused inter alia by the binning procedures in the LED industry.

The operating current for OLEDs scales with the active illuminating area however, which can be very variable, depending on the application. In this respect, it is desirable to configure OLED drivers so that the same can load the OLED with a different current depending on the size thereof.

An electronic driver apparatus and a method for controlling an organic light-emitting diode are known from the document U.S. 2011/0140626 A1. The driver apparatus has a control apparatus, which is configured to generate a pulsed current with a pulse frequency in the range of 100 Hz to 2 kHz.

Further driver and control apparatuses and also methods for controlling OLEDs are disclosed in the documents U.S. 2009/0079355 A1, U.S. 2009/0295778 A1 and U.S. 2008/0258695 A1.

### BRIEF SUMMARY

It is the object to specify improved driver technologies for a light-emitting device with one or a plurality of light-emitting organic diodes. It should be possible to operate the organic light-emitting diodes more efficiently. Furthermore, the service life of the light-emitting device should be optimised.

This object is achieved by means of a method for operating a light-emitting device according to the independent claim 1. Furthermore, an arrangement according to the independent claim 9 is provided. Advantageous configurations are the subject matter of dependent claims.

One aspect comprises the idea of a method for operating a light-emitting device, wherein, in the method, a pulsed current is generated with a pulse frequency by a driver circuit, which has a clock pulse generator providing clock pulse signals for current pulsing, and a light-emitting device, which functionally couples to the driver circuit and which is formed with one or a plurality of organic light-emitting diodes, is loaded with the pulsed current with a pulse frequency of approximately 10 kHz to approximately 100 kHz, wherein: T_PWM<(T_rise+T_fall) and wherein T_PWM indicates the pulse length for the clock pulse signals generated by the clock pulse generator of the driver circuit and T_rise and also T_fall indicate the pulse rise time and the pulse fall time for the current pulses present at the one or the plurality of organic light-emitting diodes.

Furthermore, an arrangement with the following features is disclosed:
a light-emitting device, which is formed with one or a plurality of organic light-emitting diodes, and
a driver circuit, which has a clock pulse generator providing clock pulse signals for current pulsing and functionally couples to the light-emitting device in such a manner that during operation, the light-emitting device is loaded with a pulsed current, which is generated by the driver circuit, with a pulse frequency of approximately 10 kHz to approximately 100 kHz,
   wherein the driver circuit is configured to generate the pulsed current in such a manner that: T_PWM<(T_rise+T_fall) and wherein T_PWM is the pulse length for the clock pulse signals generated by the clock pulse generator of the driver circuit and T_rise and also T_fall indicate the pulse rise time and the pulse fall time for the current pulses present at the one or the plurality of organic light-emitting diodes.

The suggested method for operating the organic light-emitting diodes in the light-emitting device corresponds to operation with a high-frequency pulsed current, wherein the organic light-emitting diodes act as low-pass filter for the pulse frequency of the pulsed current. As a result, high-frequency current signal components are filtered out. The effective current flow at the organic light-emitting diodes then corresponds approximately to the pulse duty cycle, that is to say the quotient of pulse length and pulse period duration. By means of the variation of the pulse duty cycle, any desired average current flow through the organic light-emitting diodes can be set and regulated in this manner. Energy losses during operation fall. Furthermore, the service life of the organic light-emitting diodes is prolonged.

The suggested technologies are particularly suitable for light-emitting devices, in which large-area organic light-emitting diodes are used. These include organic light-emitting diodes with an area between 1 and 1000 cm², particularly for illuminating applications. Areas of up to 1 m² can also be provided. The organic light-emitting diodes can be unstructured in this case, and consist of series- or parallel-connected sub diodes. Such an organic light-emitting diode is however operated like a single, very large organic light-emitting diode. Separate controlling of the sub diodes is generally not provided.

The operating current of the OLED depends both on the OLED architecture, for example the design as a stacked and unstacked OLED, and on the component area. In this respect, the invention has the advantage for OLEDs that a large current range can be covered with the driver electronics. In the case of other solution approaches, this is relatively complex under certain circumstances and would for example require the construction of current sources with cascaded or multiphase current drivers, which not only leads to increased component costs, but also to a larger space requirement and consequently yet higher board costs, as the current sources have to be installed multiple times. In multiphase drivers, a plurality of parallel-connected drivers are used, which are switched on when required. Drivers that are not needed can then be switched off completely and no longer require power, which leads to an efficiency improvement. The alternative regulation of the current intensity via adjustable ballast resistors or linear regulators by contrast would necessitate a large power loss and insofar would not satisfy the high demands of the lighting market for energy efficiency.

A preferred development of the invention provides that the pulsed current is generated in a regulated manner by means of the driver circuit as a pulsed nominal current as a function of one or a plurality of operating parameters that are first determined for the one or the plurality of organic light-emitting diodes and then provided in the driver circuit. The regulation on the basis of the operating parameters can be realised for example in that the pulse duty cycle, that is to say the quotient of pulse length and pulse period duration, is regulated and adjusted by means of the driver circuit for the generated current pulses in an application-dependent manner. The regulation of the pulse duty cycle can take place as a function of one or a plurality of operating parameters. These for example include a rise, a fall time, an average current and the light emission of the organic light-emitting diode. In an expedient configuration of the invention, it may be provided that an average current for the pulsed current present at the one or the plurality of organic light-emitting diodes is determined and provided as an operating parameter in the driver circuit. The average current is obtained as follows:

$$\overline{I} = {\int }_{0}^{T} I ( t ) d t / T .$$

Delta_T is a complete period. The integral can also be a discrete sum.

An advantageous embodiment of the invention provides that a current density for the one or the plurality of organic light-emitting diodes is determined from the average current and provided as an operating parameter in the driver circuit. The current density j is obtained from the average current I: j=I/A, where A is the total area for the one or the plurality of organic light-emitting diodes.

Preferably, a development of the invention provides that a planar extension of the one or the plurality of organic light-emitting diodes is determined and provided as an operating parameter in the driver circuit. The determination of the planar extension of the organic light-emitting diodes can take place in different ways. For example, it can be provided that to determine the planar extension of the organic light-emitting diodes, the same are initially loaded with a constant current, in order to measure the time until a threshold voltage is reached, which is smaller than the starting voltage of the organic light-emitting diode. An electrical capacitance of the diodes or the diode arrangement is drawn from this threshold voltage. A measure for the extent in terms of area of the organic light-emitting diodes is subsequently determined therefrom. Here, the time until the threshold voltage is reached is measured. This type of capacitive determination of the extent in terms of area of the organic light-emitting diodes can for example be executed when first switching on the light-emitting device, so that the organic light-emitting diodes can subsequently be operated on the basis of this determination of the area.

An electrical barrier layer capacitance Css is obtained as follows:

$${C}_{SS} = {\int }_{0}^{{t}_{V 1}} I ( t ) d t / {V}_{1} ,$$

where V₁ specifies the threshold voltage. The following is true: V₁<Vₜₕ (starting voltage). The barrier layer capacitance is a measure for the area of the organic light-emitting diode. The barrier layer capacitance can only be characterised in the barrier region or reverse operation of the organic light-emitting diode.

For measuring, a constant current is applied to the organic light-emitting diode and the time until the threshold voltage V1 is reached is measured. Alternatively, the current until the threshold voltage V1 is reached is integrated. The capacitance can be calculated in accordance with the above formula from the thus-obtained charge quantity and the threshold voltage V1.

In an expedient configuration of the invention, it can be provided that the one or the plurality of operating parameters are determined during the operation of the light-emitting device. Alternatively or additionally to the determination of the operating parameters, which are then used for regulating the generation of the pulsed current, it is possible during the correct operation of the light-emitting device for one or a plurality of operating parameters to be determined separately from the operation of the light-emitting device (in advance). If the light-emitting device is for example an illuminating apparatus, the determination of one or a plurality of operating parameters can alternatively or additionally also be executed in a non-illuminating state of the organic light-emitting diodes.

The pulse frequency is preferably not larger than the frequency of the switching converter (the frequency of the driver circuit), preferably not larger than 1/10 of the frequency of the switching converter, that is to say of the constant current driver for the operation of the one or the plurality of organic light-emitting diodes.

A preferred development of the invention provides that a light-emitting organic diode, which has at least one electrically doped charge carrier transport layer, is used in each case as the one or the plurality of organic light-emitting diodes. In the case of organic light-emitting diodes without electrical doping, the electrical capacitance of the components is smaller, which leads to a shorter time constant during charging and during discharging of the organic light-emitting diode and to a higher frequency when the electrically undoped diodes are operated with a comparable driver circuit. Higher pulse frequencies for the pulsed current mean greater switching losses and as a result, lower overall efficiency. The use of electrically doped organic light-emitting diodes has an efficiency increase as the advantage. For the same pulse frequency of the pulsed current, the electrical doping leads to a prolonging of the service life, as the fluctuation of the pulsed current in the switching phases turns out to be lower in the case of doped diodes and as a result, the maximum brightness, which influences the service life, is also smaller.

In an expedient configuration of the invention, it may be provided that the light-emitting device is operated as an illuminating apparatus, in which a light-emitting illuminating area is formed by the one or the plurality of organic light-emitting diodes. In this case, the use of the method in illuminating apparatuses with large-area illuminating areas is preferred.

In connection with the arrangement that comprises the light-emitting device with the one or the plurality of organic light-emitting diodes and also the driver circuit, advantageous configurations can accordingly be provided for the previous method procedures.

The control unit has a microcontroller, which is also an FPGA (Field Programmable Gate Array) or a similar programmable logic component, which acts as microcontroller.

In a development of the invention, it is provided that organic light-emitting diodes with a passivation region are used. These are organic light-emitting diodes, which have an insulating layer between the electrodes in part regions, which prevents the (light-emitting) action of the organic light-emitting diode in this region. A pattern may be created for example as a result. The organic light-emitting diodes with the passivation region can be classified into two variants and controlled using the driver:
i) The passivation can be so thick that the electrical capacitance in the passivation region does not distort the capacitance of the illuminating area of the organic light-emitting diode (active area). The capacitance can be calculated by means of equations for a plate capacitor. The electrical capacitance of the passivation region should be less than 10% of the entire measured electrical capacitance. Because the measured capacitance is proportional to the active area, no changes have to be made to the driver circuit and the control method.
ii) The passivation is so thin that the entire measured electrical capacitance is changed. In this case, two values, which are calculated from the maximum non-passivated area, the thicknesses of the undoped layer and the thickness of the passivation, must be stored in the driver circuit for calculating the passivated area. The active area of the organic light-emitting diode can be determined from the measured capacitance using these values. This area must then be taken into account for operating the driver circuit.

### BRIEF DESCRIPTION OF THE DRAWINGS

The invention is explained in more detail in the following on the basis of exemplary embodiments with reference to figures of a drawing. In the figures:

FIG. 1 shows a schematic illustration of an arrangement with a driver circuit, which is functionally coupled to an organic light-emitting diode,

FIG. 2 shows a schematic illustration of an arrangement, in which the arrangement from FIG. 1 is augmented by a measuring apparatus for determining the average current at the organic light-emitting diode,

FIG. 3 shows a schematic illustration for explaining the pulse duty cycle for the pulsed current,

FIG. 4 shows a graphical illustration for the luminance as a function of the pulse duty cycle for various pulse frequencies of the pulsed current,

FIG. 5 shows a graphical illustration of the temporal current curve for various pulse duty cycles at a pulse frequency of 500 Hz,

FIG. 6 shows a graphical illustration of the temporal current curve for various pulse duty cycles at a pulse frequency of the pulsed current of 10 kHz,

FIG. 7 shows a graphical illustration for the CIE value and also the luminance as a function of the pulse frequency of the pulsed current at a constant pulse duty cycle of 25%,

FIG. 8 shows a graphical illustration for the switch-on behaviour of organic light-emitting diodes during constant-current operation, wherein the voltage is shown as a function of the time for various organic light-emitting diodes,

FIG. 9 shows a schematic illustration of a layer stack of an organic light-emitting diode with a thick passivation layer in cross section, and

FIG. 10 shows a schematic illustration of a layer stack of an organic light-emitting diode with a thin passivation layer in cross section.

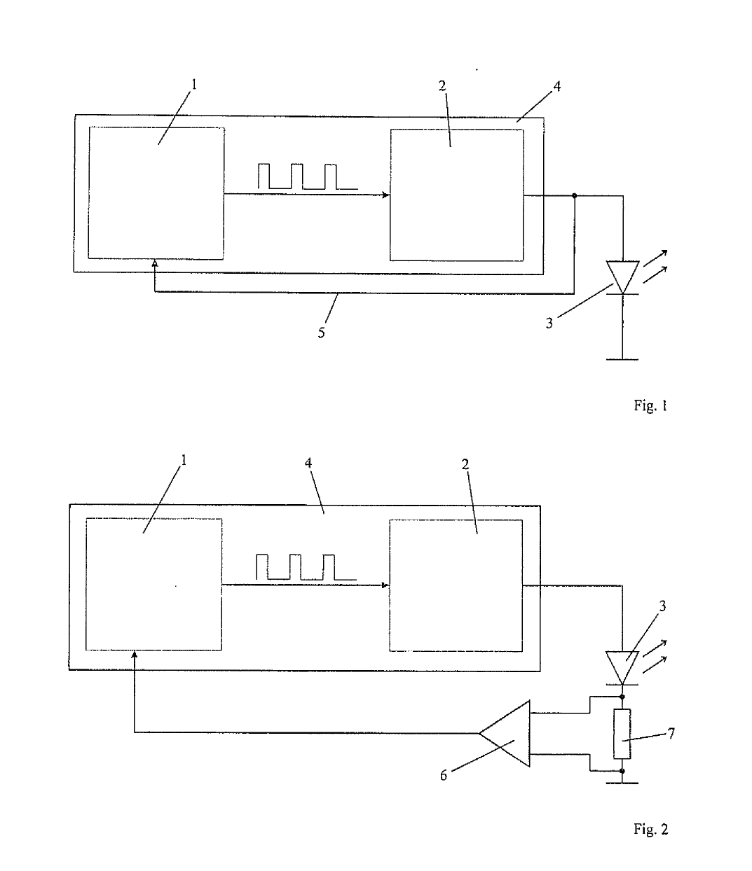

FIG. 1 shows a schematic illustration of an arrangement with a microcontroller 1 and a pulse-width controller 2, the output of which couples to an organic light-emitting diode 3. The microcontroller 1 and the pulse-width controller 2 form a driver circuit 4, using which a pulsed current is generated, which is coupled to the organic light-emitting diode 3 during operation. According to the illustration in FIG. 1, a feedback of the output of the pulse-width controller 2 to the microcontroller 1 takes place via a feedback line 5. The feedback is used for a measurement, which can be used in order to determine the capacitance or the instantaneous current.

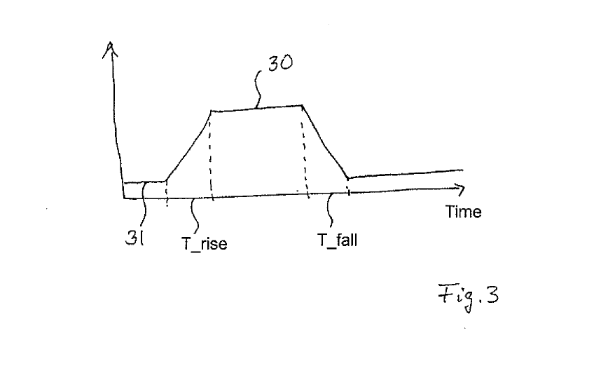

FIG. 2 shows a schematic arrangement, in which the arrangement from FIG. 1 is augmented by a measuring circuit 6, using which an average current is measured at the organic light-emitting diode 3 during operation, in that the average current is tapped via a resistor 7. The measuring apparatus 6 couples, just like the feedback line 5, to the input of the microcontroller 1. In an alternative configuration, it can be provided that the feedback line 5 is omitted in the arrangement from FIG. 2.

With the aid of the arrangement illustrated in FIG. 2, the average current measured during operation at the organic light-emitting diode 3 is provided as an operating parameter in the microcontroller 1, so that the generation of the pulsed current can be regulated as a function thereof in the driver circuit 4. In one embodiment, the organic light-emitting diode 3 is measured during the switch-on procedure. Then, the operating parameters are determined on the basis of a table, which is stored in the microcontroller 1 and contains a previously determined association between possible measured values on the one hand and respectively associated operating parameters on the other hand. It is not constant regulation, but rather only a control with the aid of the parameters determined at the start, that takes place in this embodiment. In a different embodiment, the pulse duty cycle is adjusted during operation, in order to determine the average desired operating current. The same can be measured directly and averaged in the microcontroller, or the averaging takes place by means of a low-pass filter between the measuring apparatus 6 and the microcontroller 1.

To regulate the pulsed current generated with the driver circuit 4, the pulse duty cycle, which is also termed duty cycle, can for example be varied. FIG. 3 shows a schematic illustration for this. The pulse duty cycle is determined from the quotient of pulse length and pulse period duration. In the graphical illustration in FIG. 3, this means the ratio of pulse top 30 and pulse bottom 31. Likewise schematically illustrated in FIG. 3 are the characteristic variables T_rise and T_fall, that is to say the pulse sections from pulse bottom to pulse top and also the return from pulse top to pulse bottom.

By means of a variation of the pulse duty cycle, any desired average current flow can in this case be realised directly in the organic light-emitting diode 3. Commercially available LED drivers provide a constant current and typically use switching frequencies of 100 Hz to a few kHz for the modulation of this current signal. As a consequence, the set current value, which therefore inter alia determines colour and homogeneity, acts in the organic light-emitting diode 3. In audio applications, amplifiers of Class D (also termed “digital amplifiers”) are known, which operate with switching frequencies of 48 kHz and have high output powers up to 500W when driving large ohmic loads.

The electrical capacitance of the organic light-emitting diode 3 can be described in a simple model as a plate capacitor, wherein the plate spacing is given by the thickness of the electrically undoped organic layers of the layer stack in the diode and the area of the plates is given by the active area of the organic light-emitting diode 3. For electrically doped OLEDs in particular, that is to say diodes with one or a plurality of electrically doped regions in the stack of organic layers, the capacitance of the organic light-emitting diodes 3 is particularly high, as due to the use of doped charge transport layers, the intrinsic layer thickness and thus the spacing of the capacitor plates is very low. With active areas of organic light-emitting diodes for illuminating applications of approximately 25 . . . 150 cm², capacitance values of C≈1 . . . 10 μF result, depending on the layer stack structure. Assuming lead resistances of R≈1 . . . 10 Ω, time constants are then obtained in the order of magnitude of τ1 . . . 100 μs.

A 1st-order passive low-pass filter therefore has cut-off frequencies in the range F≈1.6 . . . 160 kHz. Sensible switching frequencies of approximately 200 kHz to 10 MHz result therefrom, in order to achieve a satisfactory damping of the high-frequency signal components and only to allow the steady component to act in the organic light-emitting diode 3. In the case of undoped organic light-emitting diodes 3, the capacitance is considerably lower, which then leads to a much shorter time constant and higher frequency. Frequencies of 500 kHz and higher are required there. As higher frequencies mean more switching losses and thus a lower overall efficiency, the electrical doping is an advantage for an efficiency increase. At the same frequency, doping leads to a prolonging of services life, as the current ripple (fluctuation of the current in the switching phases) turns out to be lower in the case of doped organic light-emitting diodes 3 and thus the maximum brightness, which influences the service life, is also lower.

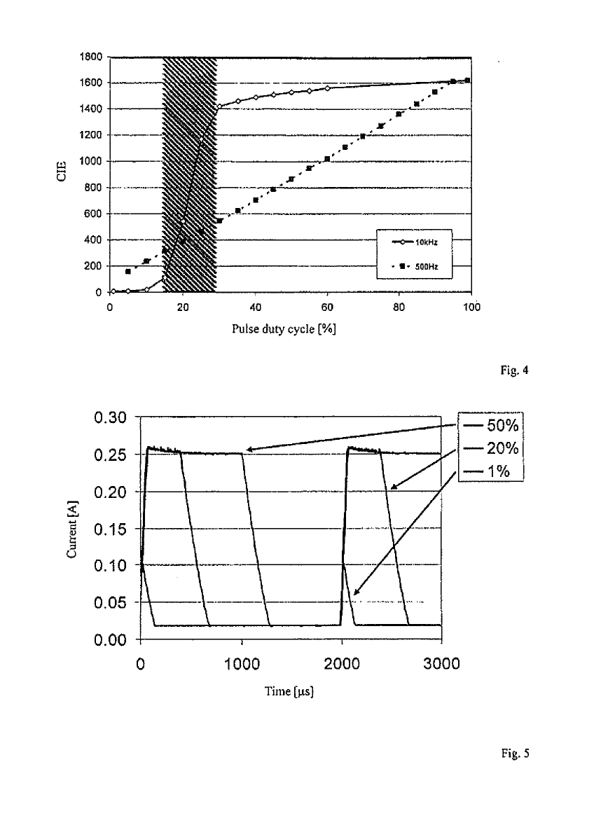

FIG. 4 shows a graphical illustration for the luminance as a function of the pulse duty cycle for various pulse frequencies of the pulsed current. At a pulse frequency of 500 Hz of the pulsed current generated with the driver circuit 4, the luminance depends linearly on the pulse duty cycle. At a pulse frequency of 10 kHz, the luminance changes as a function of the pulse duty cycle. This was observed in a range of the pulse duty cycle of approximately 15% to approximately 30%. Outside of this range of the pulse duty cycle, the luminance was essentially constant.

FIG. 5 shows a graphical illustration of the temporal current curve for various pulse duty cycles at a pulse frequency of 500 Hz. FIG. 5 shows a conventional operating mode for dimmed organic and inorganic light-emitting diodes. The rise time and the fall time can be seen clearly. As this has a disruptive effect on simple operation, in which the pulse duty cycle is directly proportional to the light-emitting diode, attempts are made in the prior art to choose a low pulse frequency, in order to reduce the influence of rise time and fall time.

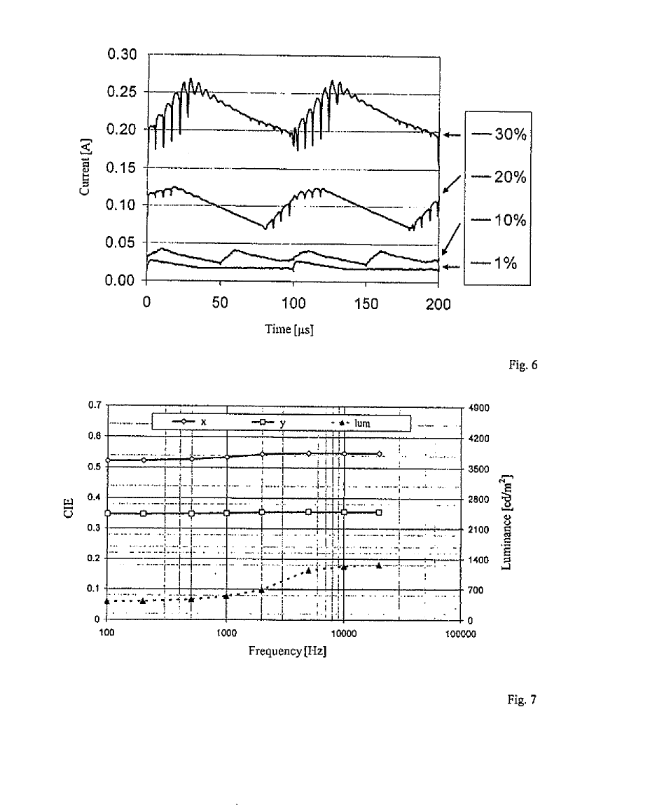

FIG. 6 shows a graphical illustration of the temporal current curve for various pulse duty cycles at a pulse frequency of the pulsed current of 10 kHz. The period duration is smaller here than the rise time and the fall time together, and at a pulse duty cycle of 20%, the current does not become zero and the maximum value is not reached either. A sawtooth current flow is obtained. The lower maximum value has a positive effect on the service life of the organic light-emitting diode.

FIG. 7 shows a graphical illustration for the CIE value and also the luminance as a function of the pulse frequency of the pulsed current at a constant pulse duty cycle of 25%. It was determined that at frequencies above 500 Hz, the luminance and the colour value are no longer constant.

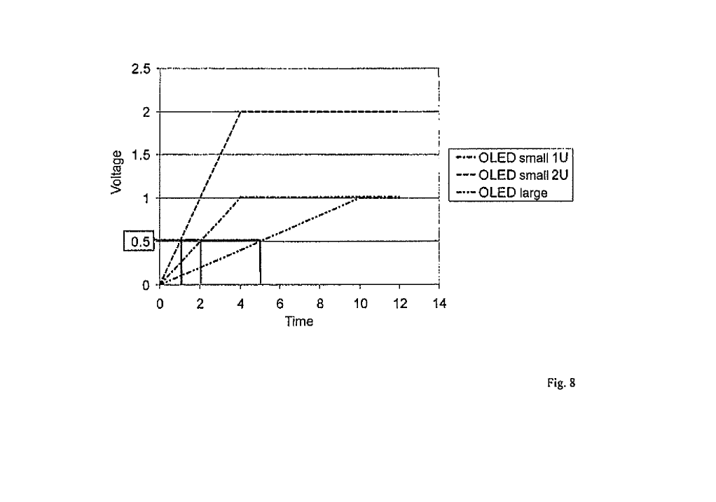

FIG. 8 shows a graphical illustration for the switch-on behaviour of organic light-emitting diodes during constant-current operation, wherein the voltage is shown as a function of the time for various organic light-emitting diodes.

The ratio of the active area to the total area of the organic light-emitting diode can be determined from the experimentally determined values:

$${I}_{ratio} = {C}_{measured} \frac{d ( d + {d}_{passivation} )}{{z}_{α} {z}_{r} \cdot A - {d}_{passivation}} - \frac{d}{{d}_{passivation}} ,$$

where C_{measured} represents a barrier layer capacitance of the organic light-emitting diode determined in the measuring cycle, d represents the total thickness of the undoped layers between electrodes of the organic light-emitting diode, dₚₐₛₛᵢᵥₐₜᵢₒₙ represents the thickness of a passivation layer of the organic light-emitting diode, A represents the total area of the organic light-emitting diode (sum of active illuminating area and passivated non-illuminating area), εₒ represents the dielectric constant and εᵣ represents the relative dielectric constant.

Iratio specifies the ratio of the active area to the total area of the organic light-emitting diode, which must be applied to the current to be emitted in order to achieve the same brightness that a non-passivated organic light-emitting diode would achieve. The current is proportional to the active (illuminating) area of the organic light-emitting diode. The maximum area is reference. The quotient “measured area”/“maximum area” is multiplied with the desired current that would be applied to the maximum area.

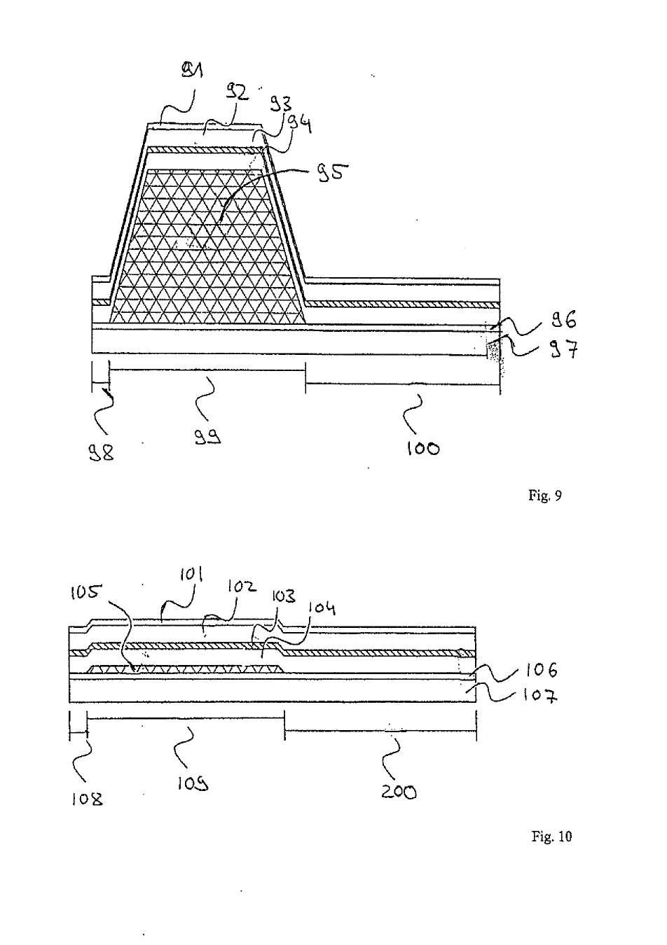

FIG. 9 shows a schematic illustration of a layer stack of an organic light-emitting diode with a thick passivation layer in cross section. The layer stack of the organic light-emitting diode comprises a top electrode 91, a doped transport layer 92, at least one undoped layer 93, a further doped transport layer 94, a passivation layer 95, a base electrode 96 and a substrate 97. Active regions 98, 100 of the organic light-emitting diode are formed on the left and the right side, whilst the region 99 therebetween is not active.

FIG. 10 shows a schematic illustration of a layer stack of an organic light-emitting diode with a thin passivation layer in cross section. The layer stack of the organic light-emitting diode comprises a top electrode 101, a doped transport layer 102, at least one undoped layer 103, a further doped transport layer 104, a passivation layer 105, a base electrode 106 and a substrate 107. Active regions 108, 200 of the organic light-emitting diode are formed on the left and the right side, whilst the region 109 therebetween is not active.

The features of the invention disclosed in the previous description, the claims and the drawing can be of importance both individually and in any desired combination for realising the invention in its various embodiments.

1. A method for operating a light-emitting device, comprising:
generating a pulsed current with a pulse frequency by a driver circuit, which has a clock pulse generator providing clock pulse signals for current pulsing, and
loading a light-emitting device with the pulsed current with a pulse frequency of about 10 kHz to about 100 kHz, wherein the light-emitting device functionally couples to the driver circuit and comprises one or a plurality of organic light-emitting diodes,
wherein T_PWM<(T_rise+T_fall), and
wherein T_PWM indicates the pulse length for the clock pulse signals generated by the clock pulse generator of the driver circuit, and T_rise and T_fall indicate the pulse rise time and the pulse fall time for the current pulses present at the one or the plurality of organic light-emitting diodes.

2. The method according to claim 1, wherein the pulsed current is generated in a regulated manner by the driver circuit as a pulsed nominal current as a function of one or a plurality of operating parameters that are first determined for the one or the plurality of organic light-emitting diodes and then provided in the driver circuit.

3. The method according to claim 2, wherein an average current for the pulsed current present at the one or the plurality of organic light-emitting diodes is determined and provided as an operating parameter in the driver circuit.

4. The method according to claim 3, wherein a current density for the one or the plurality of organic light-emitting diodes is determined from the average current and provided as an operating parameter in the driver circuit.

5. The method according to claim 2, wherein a planar extension of the one or the plurality of organic light-emitting diodes is determined and provided as an operating parameter in the driver circuit.

6. The method according to claim 2, wherein the one or the plurality of operating parameters are determined during the operation of the light-emitting device.

7. The method according to claim 1, wherein each of the one or the plurality of organic light-emitting diodes comprise a light-emitting organic diode, which has at least one electrically doped charge carrier transport layer.

8. The method according to claim 1, wherein the light-emitting device is an illuminating apparatus, in which a light-emitting illuminating area is formed by the one or the plurality of organic light-emitting diodes.

9. An arrangement, comprising:
a light-emitting device comprising one or a plurality of organic light-emitting diodes, and
a driver circuit, which has a clock pulse generator providing clock pulse signals for current pulsing and functionally couples to the light-emitting device in such a manner that during operation, the light-emitting device is loaded with a pulsed current, which is generated by the driver circuit, with a pulse frequency of approximately 10 kHz to approximately 100 kHz,
wherein the driver circuit is configured to generate the pulsed current in such a manner that: T_PWM<(T_rise+T_fall),
wherein T_PWM indicates the pulse length for the clock pulse signals generated by the clock pulse generator of the driver circuit and T_rise and T_fall indicate the pulse rise time and the pulse fall time for the current pulses present at the one or the plurality of organic light-emitting diodes.
